(19) United States
(12) Patent Application Publication
(10) Pub. No.: US 2024/0028405 A1
(43) Pub. Date: Jan. 25, 2024

(54) OPTIMIZATION OF A PIPELINE OF SERVICES

(71) Applicant: Red Hat, Inc., Raleigh, NC (US)

(72) Inventors: Leigh Griffin, Waterford (IE); Anthony F. Carroll, Waterford (IE)

(21) Appl. No.: 17/870,515

(22) Filed: Jul. 21, 2022

(51) Int. Cl. G06F 9/50; G06F 9/48

(52) U.S. Cl. CPC G06F 9/5033; G06F 9/4887

(57) ABSTRACT

For at least some services in a pipeline of interrelated services that process transactions, a corresponding service lead time is obtained. The corresponding service lead time quantifies, for a corresponding service of the at least some services a first amount of time that an input transaction awaits servicing by the corresponding service. It is determined that a lead time of a first service of the at least some services is below a lead time threshold. In response to determining that the lead time of the first service is below the lead time threshold, a throughput enhancement of an upstream service is caused.

### BACKGROUND

Processing requests with a plurality of services can be facilitated by a container orchestration system. The container orchestration system can generate and manage a plurality of containers, in which the different containers can be associated with different services being completed.

### SUMMARY

The examples implement mechanisms for optimizing a pipeline of interrelated services. A plurality of times associated with a plurality of respective services in a pipeline of services can be obtained and/or generated. The plurality of times can be processed to determine whether a throughput enhancement can be utilized for optimization. The throughput enhancement can occur in response to one or more times of the plurality of times being below and/or above a threshold. The throughput enhancement can include an adjustment of the allocation of resources and/or an adjustment of a number of instances of a particular service.

In one example, a method can be provided. The method can include obtaining, for at least some services in a pipeline of interrelated services that process transactions, a corresponding service lead time. The corresponding service lead time can quantify for a corresponding service of the at least some services a first amount of time that an input transaction awaits servicing by the corresponding service. The method can include determining that a lead time of a first service of the at least some services is below a lead time threshold. In response to determining that the lead time of the first service is below the lead time threshold, the method can include causing a throughput enhancement of an upstream service.

In another example, a computing system can be provided. The computing system can include a memory and a processor device coupled to the memory. The processor device is to obtain, for at least some services in a pipeline of services that process transactions, a corresponding service lead time and a corresponding service cycle time. The corresponding service lead time can quantify for a corresponding service of the at least some services a first amount of time that an input transaction awaits servicing by the corresponding service. The corresponding service cycle time can identify a second amount of time for performing the respective service. The processor device is further to determine a trigger event based on at least one of a lead time of a first service of the at least some services or a cycle time of the first service. The processor device is further to cause a throughput enhancement of an upstream service, in response to determining the trigger event.

In yet another example, a non-transitory computer-readable storage medium can be provided. The non-transitory computer-readable storage medium can include executable instructions to cause one or more processor devices of one or more computing devices to perform one or more operations. The instructions can cause the one or more processor devices to obtain a plurality of service lead times. The plurality of service lead times can be associated with a plurality of services of a pipeline of services that process transactions. Each service lead time of the plurality of service lead times can be associated with a respective service of the plurality of services. In some implementations, each service lead time can identify a first amount of time between a completion of a first transaction of the respective service and a beginning of a second transaction of the respective service. The instructions can further cause the one or more processor devices to determine a trigger event has occurred based on one or more of the plurality of service lead times. The trigger event can be descriptive of a queue backlog. The instructions can further cause the one or more processor devices to cause a throughput enhancement of a particular service of the plurality of services, in response to determining the trigger event has occurred based on the one or more of the plurality of service lead times.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which optimization of a pipeline of services can be practiced according to one implementation.

FIG. 2 depicts a block diagram of an example optimization of a pipeline of services according to example implementations of the present disclosure.

FIG. 3 depicts a block diagram of an example optimization of a pipeline of services according to example implementations of the present disclosure.

FIG. 4 depicts a flow chart diagram of an example method to perform optimization of a pipeline of services according to example implementations of the present disclosure.

FIG. 5 depicts a flow chart diagram of an example method to perform optimization of a pipeline of services according to example implementations of the present disclosure.

FIG. 6 depicts a flow chart diagram of an example method to perform optimization of a pipeline of services according to example implementations of the present disclosure.

FIG. 7 is a simplified block diagram of the environment illustrated in FIG. 1 according to one implementation.

FIG. 8 depicts a block diagram of an example computing system that performs optimization of a pipeline of services according to example implementations of the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

The implementation of a pipeline of services can include a plurality of services being performed by one or more processor devices. The processing of the various services can include the use of a container orchestration system and/or a hypervisor. As the various services are performed, one or more services may overperform, which can put pressure on system components further down the pipeline of services by creating queues of work and can cause failures. In particular, an adjustment based on a spike in activity may be performed too late to prevent a failure. It can additionally cause a starvation of services, dropping the utilization, which can waste CPU cycles on running services.

Generally, the present disclosure is directed to optimizing service management for a pipeline of services. In particular, implementations disclosed herein can leverage lead time determination and analysis for determining whether and/or how to adjust cycle times of one or more services. For example, for each service in a pipeline of services that process transactions, a corresponding service lead time may be obtained. The service lead time can identify a first elapsed time between two services finishing and starting. It may be determined that a lead time of a first service is below a lead time threshold. In some implementations, a throughput enhancement of an upstream service may be caused in response to determining that the lead time of the first service is below the lead time threshold.

A pipeline of services can include a plurality of services, and each service of the plurality of services can include one or more tasks. Additionally and/or alternatively, the pipeline of services can include a plurality of transactions for each respective service in the pipeline of services in order to complete an overall transaction. For example, each overall transaction can include a plurality of sub-transactions that can be associated with the plurality of different services in the pipeline of services. In particular, each service can perform a transaction, which can be the input transaction of the next downstream service. In association with the plurality of transactions, each service can have a respective cycle time and a respective lead time. The cycle time can be descriptive of an amount of time to complete a single cycle of the service. A single cycle can be a single performance of a transaction associated with the respective service. The lead time can be descriptive of the amount of time between cycles. The cycle times and/or the lead times can be tracked as the times can be descriptive and/or predictive of the starvation of one or more services as the difference between cycle times and/or lead times of related services grow. For example, one or more of the services may outperform the related services, which can cause the starvation of services.

Optimizing the pipeline of services can include continuously obtaining and processing lead times to determine whether the lead times meet a lead time threshold that can be indicative of a trigger event in which a queue backlog may occur. In response to the determination, a throughput enhancement can be determined and implemented. The throughput enhancement can be an adjustment intended to affect a cycle time of one or more services. For example, the throughput enhancement can include adjusting the allocation of computational resources. In particular, a service can receive an increased allocation of resources, which can reduce the cycle time leading to more transactions for the particular service. Alternatively and/or additionally, the throughput enhancement can include interacting with a container orchestration system to generate additional containers, which can then increase the number of parallel instances for performing transactions of a particular service. Increasing the number of parallel instances can reduce the potential of a queue backlog as requests for transactions are processed in parallel.

The optimization of the pipeline of services can be particularly helpful for pipelines of services with a mix of transaction processing in containers and transaction processing in virtual machines. The optimization can coordinate with hypervisor(s) and container orchestration system(s) to provide more comprehensive control, which can ensure the mitigation of queue backlogs.

The various implementations of the present disclosure provide a number of technical effects and benefits. As one example, the implementations can optimize a pipeline of services. For example, the pipeline optimizer disclosed herein can adjust the cycle time and/or a lead time for one or more services, which can then be utilized to reduce the queue length of the one or more services. The cycle time and/or the lead time can be adjusted based on computing resource reallocation, instance adjustment, and/or via a variety of other techniques.

Another technical benefit of the various implementations of the present disclosure is the ability to leverage a pipeline optimizer to track lead times and cycle times and can determine interrelated relationships between different services in order to reduce the probability of queue backlogging. For example, the implementations disclosed herein can track the times, determine a deviation from normal, determine one or more related services, and can adjust the cycle time and/or the lead time of one or more related services.

Another example of technical effect and benefit relates to improved computational efficiency and improvements in the functioning of a computing system. For example, one or more implementations disclosed herein can leverage the pipeline optimizer to reallocate resources to reduce the backlogging of queued requests. Additionally, the implementations disclosed herein can reduce the computational power utilized for overperforming services.

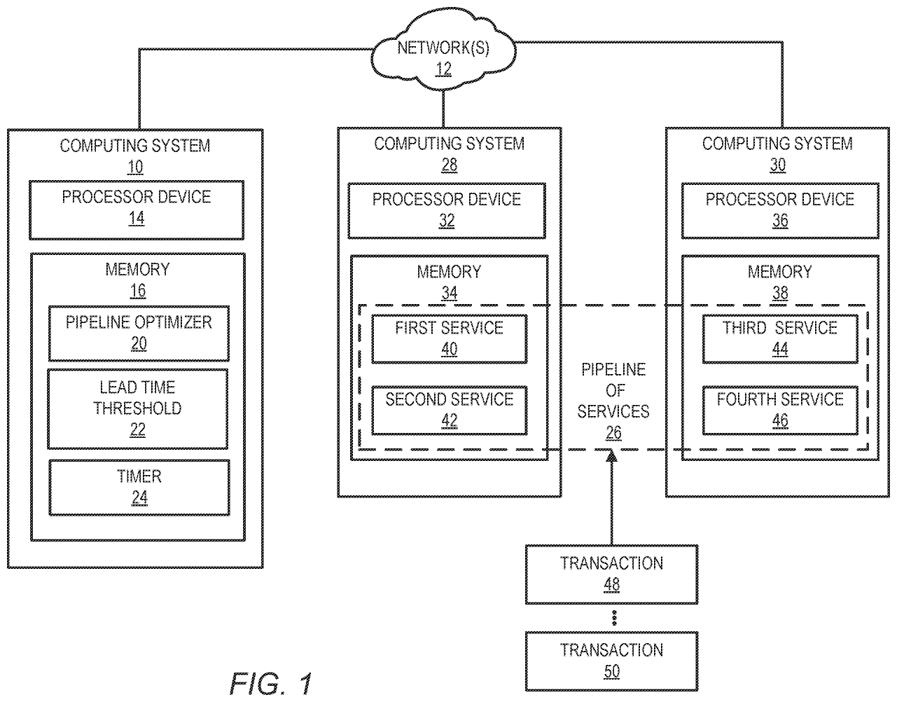

FIG. 1 is a block diagram of an environment suitable for implementing an example optimization of a pipeline of services according to example implementations of the present disclosure. A computing system 10 can be communicatively connected to a network 12. Additionally and/or alternatively, the computing system 10 can include processor device(s) 14 and memory 16. In some implementations, the computing system 10 may be a computing system that includes multiple computing devices. Alternatively, in some implementations, the computing system 10 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). The memory 16 of the computing system 10 can store data that can include and/or be utilized to implement a pipeline optimizer 20, a lead time threshold 22, and/or a timer 24. The pipeline optimizer 20 can include one or more machine-learned models and/or can include one or more deterministic functions. The pipeline optimizer 20 can be utilized to determine and/or implement one or more throughput enhancements based on obtained time data associated with the services of a pipeline of services 26. Additionally and/or alternatively, the pipeline optimizer 20 can interact with one or more hypervisors and/or one or more container orchestration systems to implement one or more throughput enhancements. The lead time threshold 22 can be predetermined, can be machine-learned, and/or can be a weighted average of a predetermined value and one or more machine-learned values. The timer 24 can interact with an internal clock of the computing system 10 in order to generate the plurality of cycle times and the plurality of lead times. Alternatively and/or additionally, the timer 24 may obtain time data via the network 12.

The source computing system 10 can communicate with one or more additional computing systems via the network 12. For example, the source computing system can communicate with a first additional computing system 28 and a second additional computing system 30. The first additional computing system 28 can include a processor device 32 and a memory 34. The second additional computing system 30 can include a processor device 36 and a memory 38. The first additional computing system processor device 32 and/or the second additional computing system processor device 36 may include any computing or electronic device capable of executing software instructions to implement the functionality described herein. The first additional computing system memory 34 and/or the second additional computing system memory 38 can be or otherwise include any device(s) capable of storing data, including, but not limited to, volatile memory (random access memory, etc.), non-volatile memory, storage device(s) (e.g., hard drive(s), solid state drive(s), etc.).

The pipeline of services 26 can include one or more services associated with the one or more additional computing systems. For example, a first service 40 and a second service 42 of the pipeline of services 26 can be stored in the memory 34 of the first additional computing system 28. Additionally and/or alternatively, a third service 44 and a fourth service 46 of the pipeline of services 26 can be stored in the memory 38 of the second additional computing system 30.

Additionally and/or alternatively, the pipeline of services can be associated with a plurality of transactions, which can include a first transaction 48 and a second transaction 50. The first transaction 48 and the second transaction can be associated with a same service and/or can be associated with different services.

The source computing system 10 can receive a request. The request can be processed to determine and/or generate the pipeline of services 26. The pipeline of services 26 can be performed. As the pipeline of services 26 are performed, the one or more timers 24 can determine a plurality of cycle times associated with the plurality of services 40-46 and can determine a plurality of lead times associated with the plurality of services 40-46. The plurality of cycle times and the plurality of lead times can be processed by the pipeline optimizer to determine a throughput enhancement can be made to improve a throughput time. The pipeline optimizer 20 may utilize the lead time threshold 22 to determine a throughput enhancement can be useful. The pipeline optimizer 20 can determine which cycle times to adjust and how much adjustment to make. The throughput enhancement can then be determined. Instructions for performing the throughput enhancement can then be transmitted via the network 12.

During heavy processing, such as when a relatively large number of transactions in a relatively short period of time are input into the pipeline of services 26, one or more services 40-46 may have cycle times and/or lead times that cause a bottleneck in the pipeline of services 26. The bottleneck can then cause certain services 40-46 to be delayed, which can cause the service-level agreement (SLA) terms to not be met. For example, one service 40-46 may accumulate a long queue, while another service 40-46 may have a significantly shorter queue. The optimization disclosed herein can mitigate and/or eliminate queue backlogs by implementing an optimization system that tracks lead times and/or cycle times of a pipeline of interrelated services 26 and can make pipeline-aware throughput enhancements based on the tracked data.

One or more services 40-46 of the pipeline of services 26 can be deployed within a container orchestration system. The container orchestration system can include an environment that has the benefit of autoscaling, in which the containers can be scaled up or down, to fine tune performance based on input. In some implementations, the container orchestration system may comprise the Kubernetes container orchestration system available at Kubernetes.io, however, the implementations are not limited to any particular type of container orchestration system, or even to a container-based pipeline of services. In some implementations the container orchestration system can be an open-source container orchestration system for automating software deployment, scaling, and management. In a container based orchestration system each of the services 40-46 may comprise a container. In a Kubernetes container orchestration system each of the services 40-46 may comprise a pod.

In some implementations, one or more of the services 40-46 may be implemented via a virtual machine. In a mixed environment, where a services pipeline may be deployed across multiple container orchestration system aware environments and non-container aware environments, the challenge can be to take the view of the overall value stream, which can be the source to the sink of the service request and can attempt to find equilibrium. A problem can occur when an overperforming part of the value stream puts pressure on system components further down the value stream by creating queues of work and causing substantial delay, or even failures, particularly in non-container aware service deployments where the adjustment based on a spike in activity could come too late to prevent a failure. The problem can additionally cause starvation of services, dropping the utilization and meaning the system may be wasting CPU cycles on running services.

Cycle time can be a metric by which the computing system 10 evaluates the performance of individual services. The cycle time can be the time the system takes for that service to perform the action the service was coded for. The lead time can be the time between two services finishing and starting. The lead time period can be where requests are queued while waiting on other actions, actors, or availability of resources. Fast cycle times flowing into slower cycle times can lead to large bottlenecks appearing as the lead time grows, putting SLAs (e.g., a service-level agreement can be a commitment between a service provider and a client. Particular aspects of the service (e.g., quality, availability, responsibilities) can be agreed upon between the service provider and the service user.) in danger as well as creating time sensitive queuing problems, particularly for requests that have a time to live component. The pipeline optimizer 20 can adjust cycle times (the time to execute) and/or can introduce deliberate constraints to looking at level loading and work-in-progress (WiP) limits.

For example, Service 1, 2, and 3 can have cycle times of 1 s, 5 s and 2 s respectively, and Service 1 can start a new execution as soon as the system is ready to start the new execution (e.g., pulling a new record for processing). In a one at a time environment, Service 2 may accumulate a large queue and may starve Service 3 of work, which can mean that Service 3 is running and waiting for work that is slowly coming to Service 3. The pipeline of services 26 can therefore complete the first entire service run in 8 s minimum on the first service request, the second service request can take 4 s of waiting between Service 1 and Service 2, and each request added can sit in the queue for the 5 s duration of the service(s) ahead of the request.

In some implementations, the pipeline optimizer 20 can optimize the cycle times and/or the lead times depending on the needs of the overall value stream.

If the adjustment keeps the system in SLA ranges (i.e., the longer time is not impactful), the impact in scenario 1, from a utilization perspective, can be that Service 3 has a higher utilization time.

If the system adjusts the cycle time of Service 2 to reduce the cycle time by 2 s, by for example, scaling up the pod, the system can positively impact the throughput of the system but can still face utilization issues

If the system introduces a work-in-progress limit of X, the system can adjust throughput, utilization, etc. The adjustment can give the computing system 10 many combinatorial options to optimize throughput in a system.

The computing system 10 can include a value stream management optimizer (e.g., a pipeline optimizer) utilized in an orchestration role. The pipeline optimizer 20 can examine the volume of client requests, the service time at individual and value stream management level stages, and the queuing and overall utilization across the entire value stream (e.g., the entire pipeline of services 26). The service can interact with the container pod scaling capabilities to improve performance (and attempt to reduce cycle time) or slow down cycle time by scaling the pod down, which can make the execution deliberately inefficient to increase cycle time. The pipeline optimizer 20 can introduce work-in-progress limits and can parallelize the execution of some key processes through spinning up multiple pods. The pipeline optimizer 20 can maintain a constant view of the utilization (which has associated costs from a cloud perspective), the queues, an overall takt time (the time for a transaction to complete), and/or individual metrics of interest. Using all of these inputs, the pipeline optimizer 20 can be able to adjust individual stations to ensure a better flow to the end user optimized by the needs of the customer. Those needs can be encoded in simple rules to govern the usage of the pipeline optimizer 20, which can provide a more dynamic and customer need driven optimization of the entire value stream. The computing system 10 can allow for real time optimization on a per request/per time basis to have a highly adaptable system.

The pipeline optimizer 20 can have the ability to use the obtained information to power down services/infrastructure that will have a lead time over X seconds, knowing the predictability of the value stream management and when a request will arrive, which can allow for optimal time to re-instantiate the service and system.

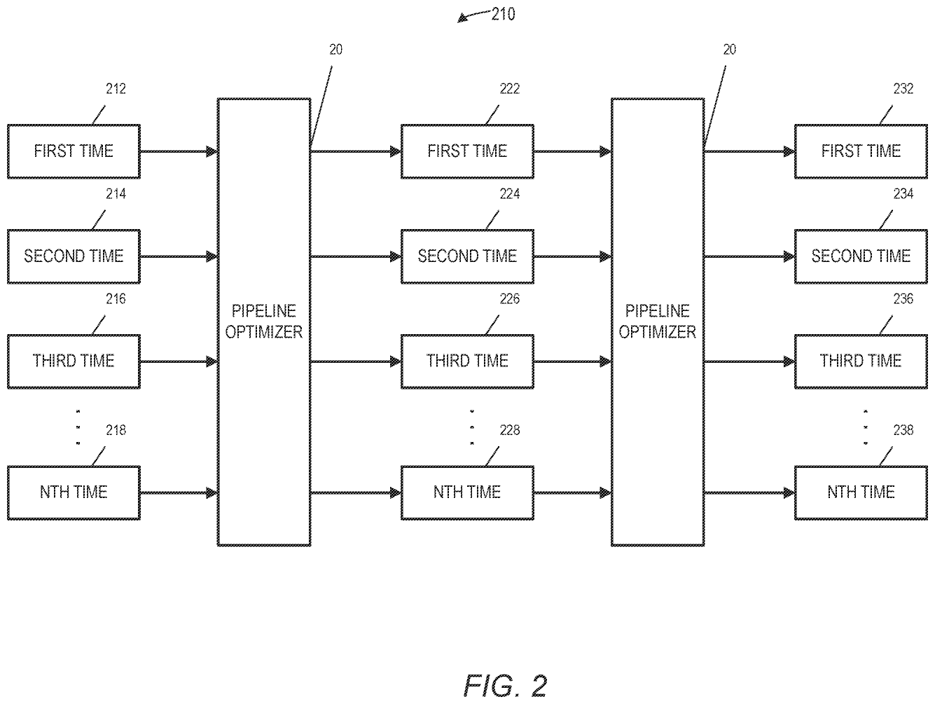

FIG. 2 depicts a block diagram of an example optimization of a pipeline of services according to example implementations of the present disclosure. A plurality of optimization cycles 210 can be performed during the performance of a pipeline of services 26. For example, a plurality of first cycle times and/or a plurality of first lead times can be obtained and processed by a pipeline optimizer 20 to determine a first throughput enhancement. The first throughput enhancement can be implemented, and a plurality of second cycle times and/or a plurality of second lead times can be obtained and processed by the pipeline optimizer 20 to determine a second throughput enhancement. The second throughput enhancement can be implemented, and the loop can be repeated again.

In particular, a first time 212 (e.g., a first cycle time and/or a first lead time) associated with a first service 40, a second time 214 (e.g., a second cycle time and/or a second lead time) associated with a second service 42, a third time 216 (e.g., a third cycle time and/or a third lead time) associated with a third service 44, and an time 218 (e.g., an nth cycle time and/or an nth lead time) associated with an nth service. The first time 212, the second time 214, the third time 216, and/or the nth time 218 can be processed by the pipeline optimizer 20 to determine whether a trigger event has occurred. A trigger event can be descriptive of a particular time (e.g., a lead time and/or a cycle time) deviating from a normal range. Alternatively and/or additionally, the trigger event can be descriptive of a particular time being below a threshold (e.g., a lead time threshold and/or a cycle time threshold). In response to determining a trigger event has occurred, the pipeline optimizer 20 can determine a throughput enhancement and can cause the throughput enhancement to occur. The throughput enhancement can include adjusting one or more cycle times of the one or more services (e.g., a cycle time of a first service 40 can be adjusted by implementing an additional instance of transaction processing for the particular service by generating an additional container for processing the service).

A plurality of updated times can then be obtained after the first throughput enhancement is implemented. A first updated time 222 (e.g., a first updated cycle time and/or a first updated lead time) associated with the first service 40, a second updated time 224 (e.g., a second updated cycle time and/or a second updated lead time) associated with the second service 42, a third updated time 226 (e.g., a third updated cycle time and/or a third updated lead time) associated with the third service 44, and an nth updated time 228 (e.g., an nth updated cycle time and/or an nth updated lead time) associated with the nth service can be obtained. One or more of the updated times may differ from their respective previous times. The first updated time 222, the second updated time 224, the third updated time 226, and/or the nth updated time may be processed by the pipeline optimizer to determine a trigger event has occurred. In response to the second trigger event being determined, a second throughput enhancement can be determined and implemented by the pipeline optimizer 20. The second throughput enhancement can cause a first additional time 232, a second additional time 234, a third additional time 236, and a fourth additional time 238 to occur. The plurality of additional times can differ from their respective previous times.

The iterative nature of the optimization loop can be based on the interdependence of the different services in the pipeline of services. For example, a change to the cycle time of the first service 40 can cause a propagation of changes to the other services (e.g., the second service 42, the third service 44, the fourth service 46, and/or the nth service). Therefore, each optimization may only include an enhancement to one or more of the services but may cause changes to non-enhanced services.

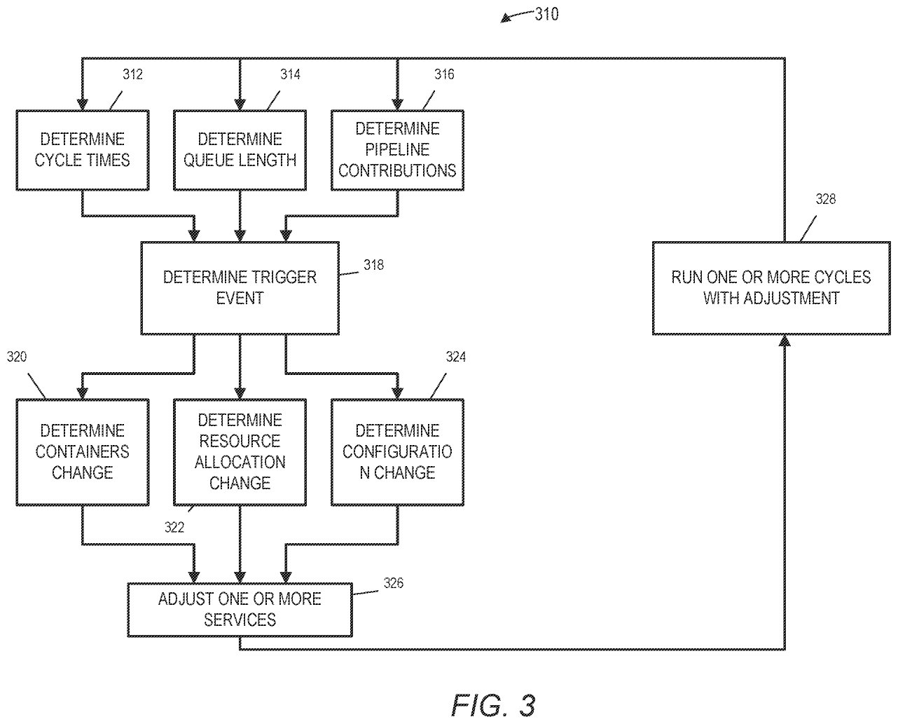

FIG. 3 depicts a block diagram of an example optimization of a pipeline of services according to example implementations of the present disclosure. The pipeline optimization system 310 can include the collection and processing of a variety of different datasets associated with the plurality of services in the pipeline of services 26. For example, the pipeline optimization system 310 can include determining cycle times (e.g., at block 312) for the plurality of services, determining a queue length (e.g., at block 314) for the plurality of services, and/or determining pipeline contributions (e.g., at block 316) for the plurality of services. Additionally and/or alternatively, lead times and/or throughput times for each of the plurality of services may be determined.

The data can then be processed to determine a trigger event (e.g., at block 318) has occurred. The trigger event can include a lead time being below a lead time threshold. Alternatively and/or additionally, the trigger event can include a lead time being above a lead time threshold. In some implementations, the trigger event can include a lead time and/or a cycle time being outside a predefined normal range of outcomes. The trigger event can be descriptive of a first lead time associated with a first service 40 being a threshold amount of time below a second lead time associated with a second service 42.

In response to determining a trigger event (e.g., at block 318) has occurred, the pipeline optimization system 310 can determine a throughput enhancement to be implemented. Determining the throughput enhancement can include at least one of determining one or more containers change (e.g., at block 320), determining a resource allocation change 322, and/or determining a configuration change (e.g., at block 324). The throughput enhancement can be implemented to adjust one or more services (e.g., at block 326). The process can then be repeated iteratively. For example, the pipeline optimization system 310 can run one or more cycles with adjustment (e.g., at block 328). Updated data can then be obtained to be processed to determine whether to implement an additional throughput enhancement.

Because the pipeline optimizer 20 can be a component of the computing system 10 (e.g., a component of a computing device), functionality implemented by the pipeline optimizer 20 may be attributed to the computing system 10 generally. Moreover, in examples where the pipeline optimizer 20 includes software instructions that program the processor device 14 to carry out functionality discussed herein, functionality implemented by the pipeline optimizer may be attributed herein to the processor device 14.

Because the pipeline optimizer 20 can be a component of the computer system 10, functionality implemented by the pipeline optimizer 20 may be attributed to the computer system 10 generally. Moreover, in examples where the pipeline optimizer 20 includes software instructions that program a processor device to carry out functionality discussed herein, functionality implemented by the pipeline optimizer 20 may be attributed herein to one or more processor devices 14 of the computer system 10.

Finally, it is noted that while, for purposes of illustration and simplicity, the implementations are illustrated as being implemented by computer system that comprises a single computing device that in turn comprises a single processor device, in practice the examples/implementations disclosed herein may be implemented in a computer system that comprises any number of computing devices, each of which may comprise one or more processor devices. Thus, irrespective of the implementation, the examples/implementations may be implemented on a computer system that includes one or more computing devices, wherein the one or more computing devices comprise one or more processor devices, and the one or more processor devices are configured to implement functionality disclosed herein.

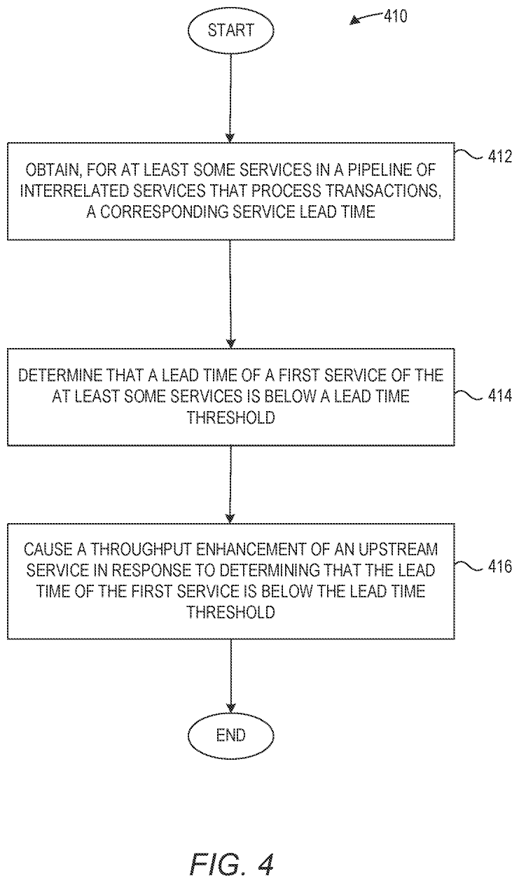

FIG. 4 depicts a flow chart diagram of an example method to perform optimization of a pipeline of services according to example implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 412, a computing system 10 can obtain, for at least some services in a pipeline of interrelated services 26 that process transactions, a corresponding service lead time. The corresponding service lead time can be descriptive of a first amount of time that an input transaction (e.g., a first transaction 48) awaits servicing by the corresponding service. Each service can include one or more tasks associated with the transaction. The corresponding lead time can be obtained from and/or determined by a timer. The timer 24 can be based on an internal clock of a computing device. In some implementations, the computing system 10 can include a plurality of timers 24 for tracking the plurality of corresponding service lead times.

In some implementations, a subset of services of the pipeline of interrelated services 26 can be implemented via containers executing in a container orchestration system. The container orchestration system can manage the generation and facilitation of containers for isolated processing. A second subset of services of the pipeline of interrelated services 26 are implemented via processes executing in virtual machines. The virtual machines can be independent of the container orchestration system. The virtual machines can be allocated computational resources of a computing device and can emulate the processing of a physical machine.

At 414, the computing system 10 can determine that a lead time of a first service of the at least some services is below a lead time threshold 22. The lead time of the first service can be descriptive of an elapsed time between the completion of a first transaction 48 of the first service 40 and a beginning of a second transaction 50 of the first service 40. The lead time threshold 22 can be predetermined and/or may be machine-learned. For example, the pipeline optimizer 20 can utilize one or more machine-learned models to optimize the allocation of resources and the number of instances for each of the plurality of services in the pipeline of interrelated services 26. The one or more machine-learned models can learn a set of parameters that can then be utilized to determine the lead time threshold 22. In some implementations, the lead time threshold 22 may vary based on the particular service. Alternatively and/or additionally, the lead time threshold 22 may be uniform for all services.

In some implementations, determining that the lead time of the first service 40 is below the lead time threshold 22 can include determining that the lead time of the first service 40 is below a predetermined threshold. The predetermined threshold may be set based on historical processing data associated with one or more services. The determination can be completed by a computing system 10 including one or more processing devices 14.

Alternatively and/or additionally, determining that the lead time of the first service 40 is below the lead time threshold 22 can include determining an association between the first service 40 and a second service 42 and determining the lead time threshold 22 based at least in part on a second lead time of the second service 42. The association can be determined based on a determined relationship between the first service 40 and the second service 42. The relationship can include an interrelated relationship of services in the pipeline of services 26 in which for every set number of transactions of a first service a set number of transactions for the second service 42 are utilized for the value stream of the pipeline of interrelated services 26.

In some implementations, determining that the lead time of the first service 40 is below the lead time threshold 22 can include determining the lead time threshold 22 based at least in part on a first queue and a second queue. The first queue can be associated with the first service 40. The second queue can be associated with a second service 42. The first queue can include an amount of transactions of the first service 40 waiting to be completed. The second queue can include an amount of transactions of the second service 42 waiting to be completed. In some implementations, the determination of the lead time threshold 22 can be based on a determination of a total amount of time for completing the transactions in each given queue. The total times can be compared to determine a difference between the first queue and the second queue.

Alternatively and/or additionally, determining that the lead time of the first service 40 is below the lead time threshold 22 can include determining the lead time threshold 22 based on a work-in-progress limit. The work-in-progress limit can be based on a predetermined maximum total queue. In some implementations, the work-in-progress limit can be based on an amount of available computational resources of the computing system 10.

At 416, the computing system 10 can cause a throughput enhancement of an upstream service (e.g., the second service 42) in response to determining that the lead time of the first service 40 is below the lead time threshold 22. The throughput enhancement can include one or more actions for adjusting a service cycle time and/or a service lead time. In some implementations, the throughput enhancement can be a predetermined action. Alternatively and/or additionally, the throughput enhancement may be an action dependent on the difference between the lead time of the first service and the lead time threshold 22 in which the throughput enhancement may be proportional to the difference.

In some implementations, causing the throughput enhancement of the upstream service can include causing an additional instance of the upstream service to be initiated. The additional instance can be initiated by generating an additional container and performing transactions of the upstream service in the additional container.

Alternatively and/or additionally, causing the throughput enhancement of the upstream service comprises allocating an additional amount of memory to the upstream service. The allocation can be based on the amount of available memory of the computing device.

In some implementations, the computing system 10 can include obtaining, for each service in the pipeline of interrelated services 26 that process transactions, a corresponding service cycle time. The corresponding service cycle time can identify a second amount of time for performing a transaction of the corresponding service. A single instance of a transaction can be a cycle. In some implementations, the pipeline optimizer 20 can determine the throughput enhancement based on one or more service cycle times.

The timer 24 can determine a throughput elapsed time for the pipeline of interrelated services 26. The throughput elapsed time can identify a total amount of time for processing a single transaction by the pipeline of interrelated services 26. The throughput enhancement can be based at least in part on the throughput elapsed time.

In some implementations, the computing system 10 can obtain, for each service in the pipeline of interrelated services 26 that process transactions, an updated service lead time. The updated service lead time can identify an updated first amount of time that the input transaction awaits servicing by the corresponding service. The pipeline optimizer 20 can determine that an updated lead time of a second service is below the lead time threshold 22. In response to determining that the updated lead time of the second service 42 is below the lead time threshold 22, the pipeline optimizer 20 can cause a second throughput enhancement of the upstream service.

Additionally and/or alternatively, in response to determining that the lead time of the first service 40 is below the lead time threshold 22, the pipeline optimizer 20 can cause a reduction in an allocated amount of memory for the first service. The reduction can be proportional to an increased allocation to the upstream service.

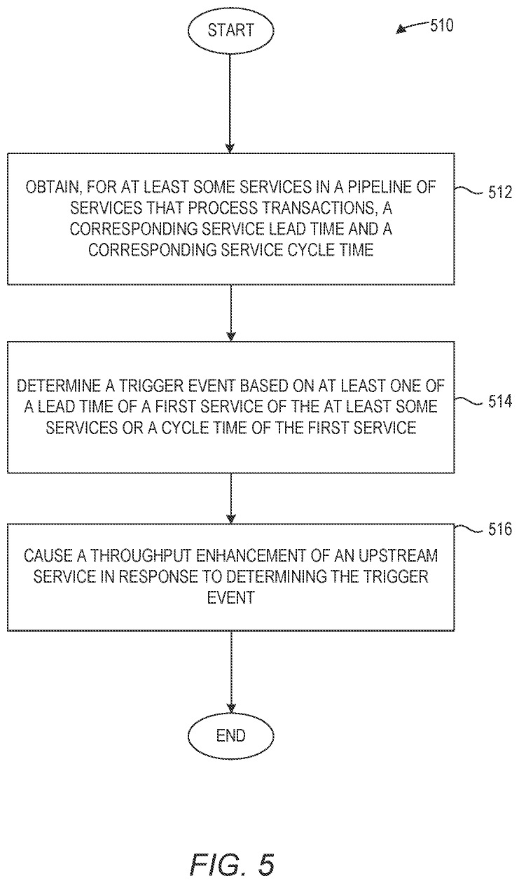

FIG. 5 depicts a flow chart diagram of an example method to perform optimization of a pipeline of services according to example implementations of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 512, a computing system 10 can obtain, for at least some services in a pipeline of services 26 that process transactions, a corresponding service lead time and a corresponding service cycle time. The corresponding service lead time can be descriptive of a first amount of time that an input transaction awaits servicing by the corresponding service (e.g., a corresponding service of the at least some services). In some implementations, the corresponding service cycle time can identify a second amount of time for performing the corresponding service.

At 514, the computing system 10 can determine a trigger event based on at least one of a lead time of a first service 40 of the at least some services or a cycle time of the first service 40. The trigger event can be descriptive of the lead time of the first service 40 being below a lead time threshold 22. The trigger event can be descriptive of the cycle time being below a cycle time threshold. Alternatively and/or additionally, the trigger event can be descriptive of the lead time and/or the cycle time being above a threshold (e.g., a lead time threshold 22 and/or a cycle time threshold). In some implementations, the trigger event may be based on a comparison between the lead time and the cycle time. For example, the cycle time when compared to the lead time may be indicative of a queue backlog.

In some implementations, determining the trigger event can include determining a queue length of the first service 40 based on at least one of the lead time or the cycle time and determining the queue length is above a queue threshold. The queue threshold can be predetermined and/or may be iteratively determined as more data is accumulated. The queue threshold may be based on the queue size of other services in the pipeline of services.

Alternatively and/or additionally, determining the trigger event can include determining the lead time of the first service 40 is less than an upstream lead time of the upstream service.

At 516, the computing system 10 can cause a throughput enhancement of an upstream service in response to determining the trigger event. The throughput enhancement can be an adjustment of allocated computing resources to the upstream service. In some implementations, the throughput enhancement can be an adjustment of the amount of parallel transaction instances for the upstream service.

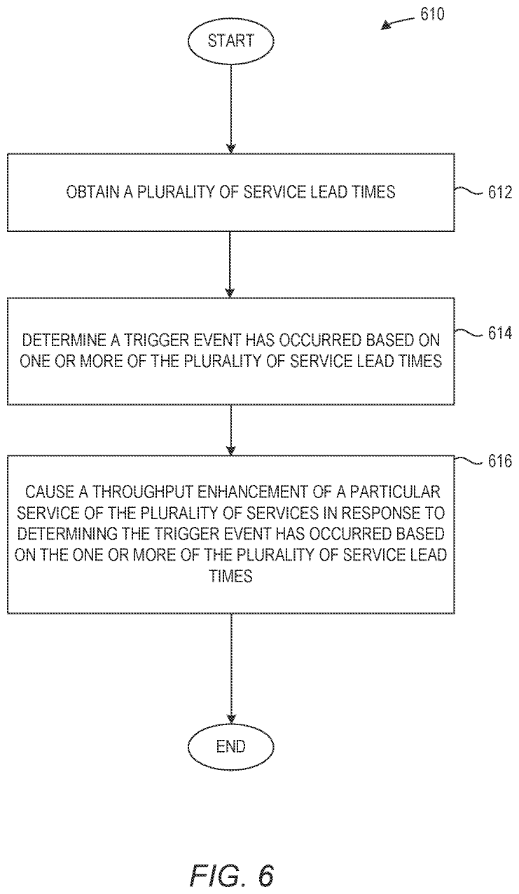

FIG. 6 depicts a flow chart diagram of an example method to perform optimization of a pipeline of services according to example implementations of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 612, a computing system 10 can obtain a plurality of service lead times. The plurality of service lead times can be associated with a plurality of services of a pipeline of services that process transactions. In some implementations, each service lead time of the plurality of service lead times can be associated with a respective service of the plurality of services. Each service lead time can identify a first amount of time between a completion of a first transaction of the respective service and a beginning of a second transaction of the respective service.

At 614, the computing system 10 can determine a trigger event has occurred based on one or more of the plurality of service lead times. The trigger event can be descriptive of a queue backlog. In some implementations, the queue backlog can be determined based on a comparison between two or more service lead times of the plurality of service lead times. The trigger event can be a deviation from a normal range of lead time values for the specific service. Alternatively and/or additionally, the trigger event may be determined by determining a standard deviation of lead times for a particular service and determining the lead time is outside of the standard deviation range.

At 616, the computing system 10 can cause a throughput enhancement of a particular service of the plurality of services in response to determining the trigger event has occurred based on the one or more of the plurality of service lead times. The throughput enhancement can be an adjustment of one or more cycle times by adjusting allocated computing resources and/or by adjusting a number of transaction instances. The enhancement adjustment may adjust one or more lead times.

In some implementations, the computing system 10 can obtain a plurality of updated service lead times, determining a second trigger event has occurred based on one or more of the plurality of updated service lead times, and causing an additional throughput enhancement of a specific service of the plurality of services. The particular service and the specific service may differ.

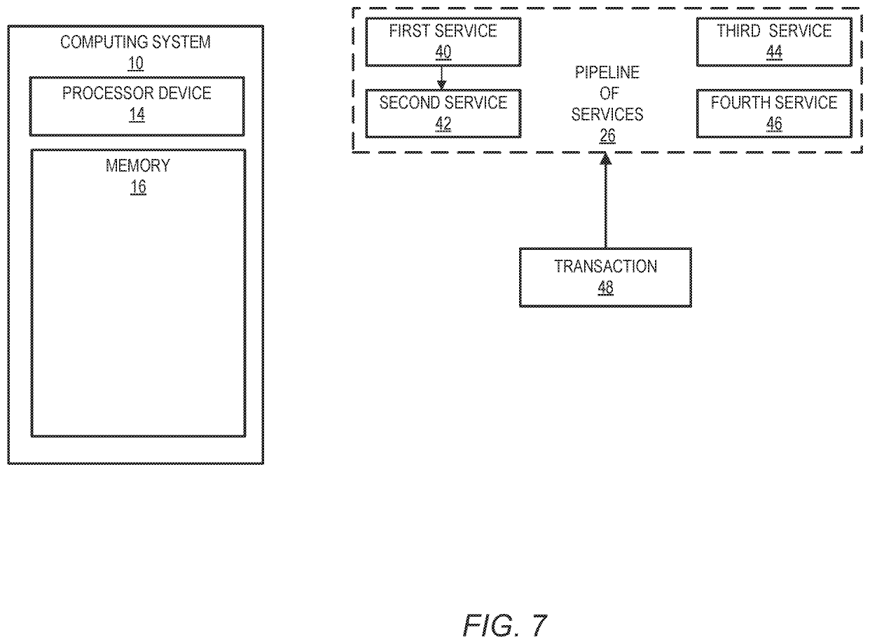

FIG. 7 is a simplified block diagram of the environment illustrated in FIG. 1 according to one implementation. The environment incudes the system which in turn includes the processor device 14 and the memory 16. The processor device 14 is coupled to the memory 16. The processor device 14 is to obtain, for at least some services 40-46 in the pipeline of services 26 that process transactions, such as the transaction 48, a corresponding service lead time and a corresponding service cycle time, the corresponding service lead time quantifying for a corresponding service 40-46 of the at least some services 40-46 a first amount of time that the input transaction awaits servicing by the corresponding service 40-46, the corresponding service cycle time identifying a second amount of time for performing the respective service 40-46. The processor device 14 is further to determine a trigger event based on at least one of a lead time of a first service 40-46 of the at least some services 40-46 or a cycle time of the first service 40-46. The processor device 14 is further to, in response to determining the trigger event, cause a throughput enhancement of an upstream service 40-46.

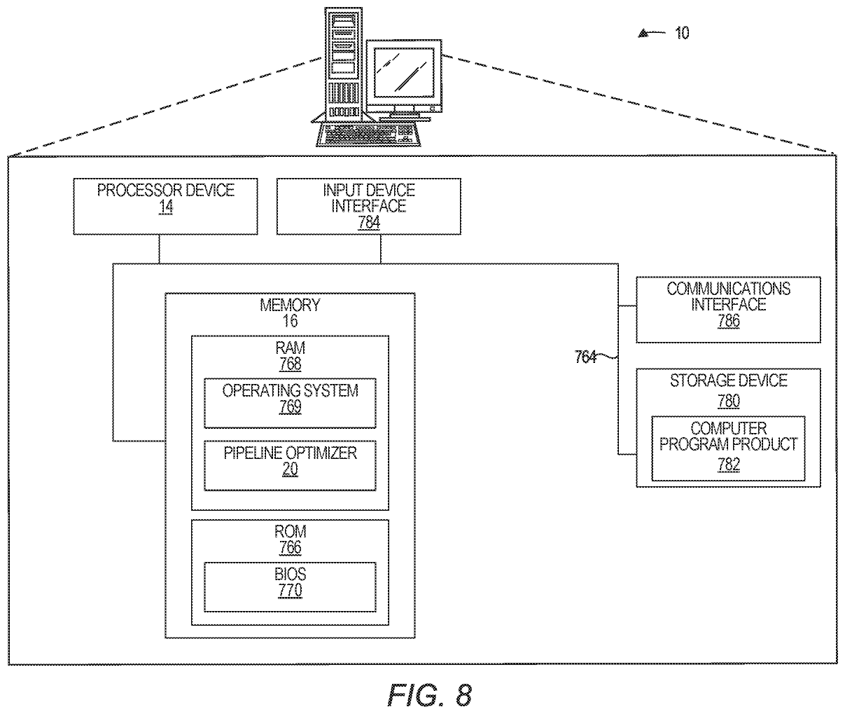

FIG. 8 is a block diagram of the source computing system 10 suitable for implementing examples according to one example. The source computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. The source computing system 10 includes the processor device 14, the system memory 16, and a system bus 64. The system bus 764 provides an interface for system components including, but not limited to, the system memory 16 and the processor device 14. The processor device 14 can be any commercially available or proprietary processor.

The system bus 764 may be any of several types of bus structures that may further interconnect to a memory bus (with or without a memory controller), a peripheral bus, and/or a local bus using any of a variety of commercially available bus architectures. The system memory 16 may include non-volatile memory 766 (e.g., read-only memory (ROM), erasable programmable read-only memory (EPROM), electrically erasable programmable read-only memory (EEPROM), etc.), and volatile memory 768 (e.g., random-access memory (RAM)). A basic input/output system (BIOS) 770 may be stored in the non-volatile memory 66 and can include the basic routines that help to transfer information between elements within the source computing system 10. The volatile memory 68 may also include a high-speed RAM, such as static RAM, for caching data.

The source computing system 10 may further include or be coupled to a non-transitory computer-readable storage medium such as the storage device 18, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 780 and other drives associated with computer-readable media and computer-usable media may provide non-volatile storage of data, data structures, computer-executable instructions, and the like.

A number of modules can be stored in the storage device 780 and in the volatile memory 768, including an operating system 769 and one or more program modules, such as the file transfer module, which may implement the functionality described herein in whole or in part. All or a portion of the examples may be implemented as a computer program product 782 stored on a transitory or non-transitory computer-usable or computer-readable storage medium, such as the storage device 780, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the file transfer module in the volatile memory 768, may serve as a controller, or control system, for the source computing system 10 that is to implement the functionality described herein.

An operator, such as the user, may also be able to enter one or more configuration commands through a keyboard (not illustrated), a pointing device such as a mouse (not illustrated), or a touch-sensitive surface such as a display device. Such input devices may be connected to the processor device 14 through an input device interface 784 that is coupled to the system bus 764 but can be connected by other interfaces such as a parallel port, an Institute of Electrical and Electronic Engineers (IEEE) 1394 serial port, a Universal Serial Bus (USB) port, an IR interface, and the like.

The source computing system 10 may also include the communications interface 786 suitable for communicating with the network 12 as appropriate or desired. The source computing system 10 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, for at least some services in a pipeline of interrelated services that process transactions, a corresponding service lead time, the corresponding service lead time quantifying for a corresponding service of the at least some services a first amount of time that an input transaction awaits servicing by the corresponding service;
determining that a lead time of a first service of the at least some services is below a lead time threshold; and
in response to determining that the lead time of the first service is below the lead time threshold, causing a throughput enhancement of an upstream service.

2. The method of claim 1, wherein causing the throughput enhancement of the upstream service comprises causing an additional instance of the upstream service to be initiated.

3. The method of claim 1, wherein causing the throughput enhancement of the upstream service comprises allocating an additional amount of memory to the upstream service.

4. The method of claim 1, further comprising:
obtaining, for each service in the pipeline of interrelated services that process transactions, a corresponding service cycle time, the corresponding service cycle time identifying a second amount of time for performing the corresponding service.

5. The method of claim 4, further comprising:
determining the throughput enhancement based on one or more service cycle times.

6. The method of claim 1, further comprising:
determining a throughput elapsed time for the pipeline of interrelated services, the throughput elapsed time identifying a total amount of time for processing a single transaction by the pipeline of interrelated services.

7. The method of claim 1, further comprising:
obtaining, for each service in the pipeline of interrelated services that process transactions, an updated service lead time, the updated service lead time identifying an updated first amount of time that the input transaction awaits servicing by the corresponding service.

8. The method of claim 7, further comprising:
determining that an updated lead time of a second service is below the lead time threshold; and
in response to determining that the updated lead time of the second service is below the lead time threshold, causing a second throughput enhancement of the upstream service.

9. The method of claim 1, wherein determining that the lead time of the first service is below the lead time threshold comprises:
determining that the lead time of the first service is below a predetermined threshold.

10. The method of claim 1, wherein determining that the lead time of the first service is below the lead time threshold comprises:
determining an association between the first service and a second service; and
determining the lead time threshold based at least in part on a second lead time of the second service.

11. The method of claim 1, wherein determining that the lead time of the first service is below the lead time threshold comprises:
determining the lead time threshold based at least in part on a first queue and a second queue, the first queue being associated with the first service, the second queue being associated with a second service.

12. The method of claim 1, wherein a subset of services of the pipeline of interrelated services are implemented via containers executing in a container orchestration system, and a second subset of services of the pipeline of interrelated services are implemented via processes executing in virtual machines, the virtual machines being independent of the container orchestration system.

13. The method of claim 1, further comprising:
in response to determining that the lead time of the first service is below the lead time threshold, causing a reduction in an allocated amount of memory for the first service.

14. The method of claim 1, wherein determining that the lead time of the first service is below the lead time threshold comprises:
determining the lead time threshold based on a work-in-progress limit, wherein the work-in-progress limit is based on a predetermined maximum total queue.

15. A computing system comprising:
a memory; and
a processor device coupled to the memory to:
obtain, for at least some services in a pipeline of services that process transactions, a corresponding service lead time and a corresponding service cycle time, the corresponding service lead time quantifying for a corresponding service of the at least some services a first amount of time that an input transaction awaits servicing by the corresponding service, the corresponding service cycle time identifying a second amount of time for performing the respective service;
determine a trigger event based on at least one of a lead time of a first service of the at least some services or a cycle time of the first service; and
in response to determining the trigger event, cause a throughput enhancement of an upstream service.

16. The computing system of claim 15, wherein to determine the trigger event, the processor device is further to:
determine a queue length of the first service based on at least one of the lead time or the cycle time; and
determine the queue length is above a queue threshold.

17. The computing system of claim 15, wherein to determine the trigger event, the processor device is further to:
determine the lead time of the first service is less than an upstream lead time of the upstream service.

18. A non-transitory computer-readable storage medium that includes executable instructions to cause one or more processor devices of one or more computing devices to:
obtain a plurality of service lead times, wherein the plurality of service lead times are associated with a plurality of services of a pipeline of services that process transactions, wherein each service lead time of the plurality of service lead times is associated with a respective service of the plurality of services, wherein each service lead time identifies a first amount of time between a completion of a first transaction of the respective service and a beginning of a second transaction of the respective service;
determine a trigger event has occurred based on one or more of the plurality of service lead times, wherein the trigger event is descriptive of a queue backlog; and
in response to determining the trigger event has occurred based on the one or more of the plurality of service lead times, cause a throughput enhancement of a particular service of the plurality of services.

19. The non-transitory computer-readable medium of claim 18, wherein the queue backlog is determined based on a comparison between two or more service lead times of the plurality of service lead times.

20. The non-transitory computer-readable medium of claim 18, wherein the instructions further cause the processor device to:
obtain a plurality of updated service lead times;
determine a second trigger event has occurred based on one or more of the plurality of updated service lead times; and
cause an additional throughput enhancement of a specific service of the plurality of services, wherein the particular service and the specific service differ.
